(19) United States
(12) Patent Application Publication
(10) Pub. No.: US 2014/0229316 A1
(43) Pub. Date: Aug. 14, 2014

(54) SYSTEMS AND METHODS FOR QUOTING VEHICLE PART REPAIRS ASSOCIATED WITH VEHICLE INSPECTIONS

(71) Applicant: Mark Brandon, Highlands Rance, CO (US)

(72) Inventor: Mark Brandon, Highlands Rance, CO (US)

(21) Appl. No.: 14/177,798

(22) Filed: Feb. 11, 2014

Related U.S. Application Data
(60) Provisional application No. 61/764,455, filed on Feb. 13, 2013.

(51) Int. Cl. G06Q 30/06

(52) U.S. Cl. CPC G06Q 30/0611
USPC 705/26.4

(57) ABSTRACT

The present disclosure is directed a vehicle inspection system for carrying out vehicle inspection and providing a quote for repair of a service recipient's vehicle, the quote being provided to a service recipient at a desired location. The vehicle inspection system includes a mobile device having a computer with a processor, a display screen, and a non-transitory computer-readable storage medium. The computer-readable storage medium includes computer-readable instructions for: displaying a graphical user interface, receiving a command to initiate vehicle inspection, determining at least one current part condition associated with at least one part of the vehicle, receiving condition data associated with the at least one current part condition, receiving vehicle identification data for the vehicle, electronically communicating the condition data and the vehicle identification data to a quoting server, receiving quote data from the quoting server, and displaying a price quote associated with the quote data.

### CROSS REFERENCE TO RELATED APPLICATIONS

This application claims priority to co-pending U.S. Provisional Application, Ser. No. 61/764,455 filed on Feb. 13, 2013, which is hereby incorporated by reference for all purposes.

### BACKGROUND

The present disclosure relates generally to systems and methods for quoting vehicle repairs. In particular, systems and methods allowing service consultants to provide quotes while remaining in the vicinity of service recipients' vehicles or at any desired location are described.

Known systems and methods for quoting vehicle repairs are not entirely satisfactory for the range of applications in which they are employed. For example, existing systems and methods require service consultants, after performing an inspection and taking hand written notes, to manually enter the results of the inspection into a computer database. This often requires service consultants to spend a significant amount of time away from the service recipient.

In some examples, service recipients must wait in their car or a waiting room as the service consultant prepares a quote in this manner. As a result, service recipients have lengthy wait times and service consultants are forced to provide limited customer service. Further, manually entering inspection results provides potential for error in entering the inspection results into the database from the service consultant's hand written notes and/or memory. Thus, there exists a need for systems and methods that allow service consultants to receive price quotes based on their inspection while remaining near service recipients and reduce the likelihood of incorrect inspection results being entered into the service center's data base.

These shortcomings may be particularly prevalent with regard to tire service quotes. In many cases, service consultants may quote tire service in a secondary quoting process performed alongside quoting for more general services. As a result, the service consultant often forgets to enter tire inspection. This may, in some cases, leave service recipients without a tire service quote. In some cases, service recipients may not be informed that their tires need replacement, even after completing more general vehicle service. Further, the service consultants may lose business as a result of forgetting to appropriately quote and/or offer tire services.

Thus, there exists a need for systems and methods that improve upon and advance known methods for quoting vehicle part repairs associated with vehicle inspections. Examples of new and useful systems and methods relevant to the needs existing in the field are discussed below.

### SUMMARY

The present disclosure is directed a vehicle inspection system for carrying out a vehicle inspection and providing a quote for repair of a service recipient's vehicle, the quote being provided to a service recipient at a desired location. The vehicle inspection system includes a mobile device, the mobile device having a computer with a processor, a display screen, and a non-transitory computer-readable storage medium. The computer-readable storage medium includes computer-readable instructions for: displaying a graphical user interface, receiving a command to initiate a vehicle inspection of the service recipient's vehicle, determining at least one current part condition associated with at least one part of the vehicle, receiving condition data associated with the at least one current part condition, receiving vehicle identification data for the vehicle, electronically communicating the condition data and the vehicle identification data to a quoting server, receiving quote data from the quoting server, and displaying a price quote associated with the quote data.

### BRIEF DESCRIPTION OF THE DRAWINGS

FIG. 1 shows a schematic view of an example of a programmable computing device.

FIG. 2 shows a schematic view of an example of a mobile electronic device.

FIG. 3 is a flow diagram of an example method for quoting vehicle part repairs associated with vehicle inspections using the mobile device of FIG. 2.

FIG. 4 is an example screenshot displaying example features of a graphical user interface used with the method shown in FIG. 3.

FIG. 5 is a screenshot displaying additional example features of a user interface used with the method shown in FIG. 3.

FIG. 6 is a screenshot displaying example features of an additional or alternative example of a user interface used with the method shown in FIG. 3.

### DETAILED DESCRIPTION

The disclosed systems and methods for quoting vehicle repairs will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, a variety of examples of systems and methods for quoting vehicle repairs are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Various disclosed examples may be implemented using electronic circuitry configured to perform one or more functions. For example, with some embodiments of the invention, the disclosed examples may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

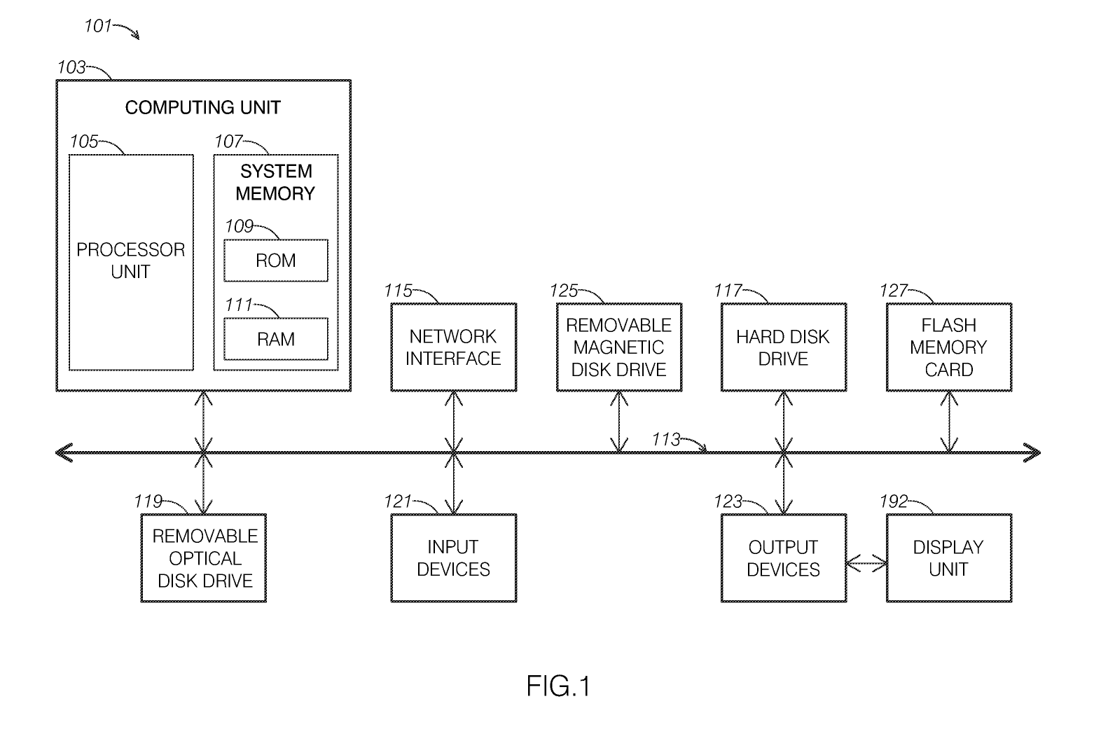

Accordingly, FIG. 1 shows one illustrative example of a computer 101 that can be used to implement various embodiments of the invention. Computer 101 may be incorporated within a variety of consumer electronic devices, such as personal media players, cellular phones, smart phones, personal data assistants, global positioning system devices, and the like.

As seen in this figure, computer 101 has a computing unit 103. Computing unit 103 typically includes a processing unit 105 and a system memory 107. Processing unit 105 may be any type of processing device for executing software instructions, but will conventionally be a microprocessor device. System memory 107 may include both a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123. Input devices 121 may include, for example, a keyboard, touch screen, a remote control pad, a pointing device (such as a mouse, touchpad, stylus, trackball, or joystick), a scanner, a camera or a microphone. Output devices 123 may include, for example, a monitor display, an integrated display, television, printer, stereo, or speakers.

Still further, computing unit 103 will be directly or indirectly connected to one or more network interfaces 115 for communicating with a network. This type of network interface 115, also sometimes referred to as a network adapter or network interface card (NIC), translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device may be connected to a variety of other peripheral devices, including some that may perform input, output and storage functions, or some combination thereof. For example, the computer 101 may be connected to a digital music player, such as an IPOD® brand digital music player or iOS or Android based smartphone. As known in the art, this type of digital music player can serve as both an output device for a computer (e.g., outputting music from a sound file or pictures from an image file) and a storage device.

In addition to a digital music player, computer 101 may be connected to or otherwise include one or more other peripheral devices, such as a telephone. The telephone may be, for example, a wireless “smart phone,” such as those featuring the Android or iOS operating systems. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 101 so that their data maintained may be synchronized.

Of course, still other peripheral devices may be included with or otherwise connected to a computer 101 of the type illustrated in FIG. 1, as is well known in the art. In some cases, a peripheral device may be permanently or semi-permanently connected to computing unit 103. For example, with many computers, computing unit 103, hard disk drive 117, removable optical disk drive 119 and a display are semi-permanently encased in a single housing.

Still other peripheral devices may be removably connected to computer 101, however. Computer 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 101 may include a wireless data “port,” such as a Bluetooth ® interface, a Wi-Fi interface, an infrared data port, or the like.

It should be appreciated that a computing device employed according various examples of the invention may include more components than computer 101 illustrated in FIG. 1, fewer components than computer 101, or a different combination of components than computer 101. Some implementations of the invention, for example, may employ one or more computing devices that are intended to have a very specific functionality, such as a digital music player or server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

In many examples, computing devices may define mobile electronic devices, such as smartphones, tablet computers, or portable music players, often operating the iOS, Symbian, Windows-based (including Windows Mobile and Windows 8), or Android operating systems.

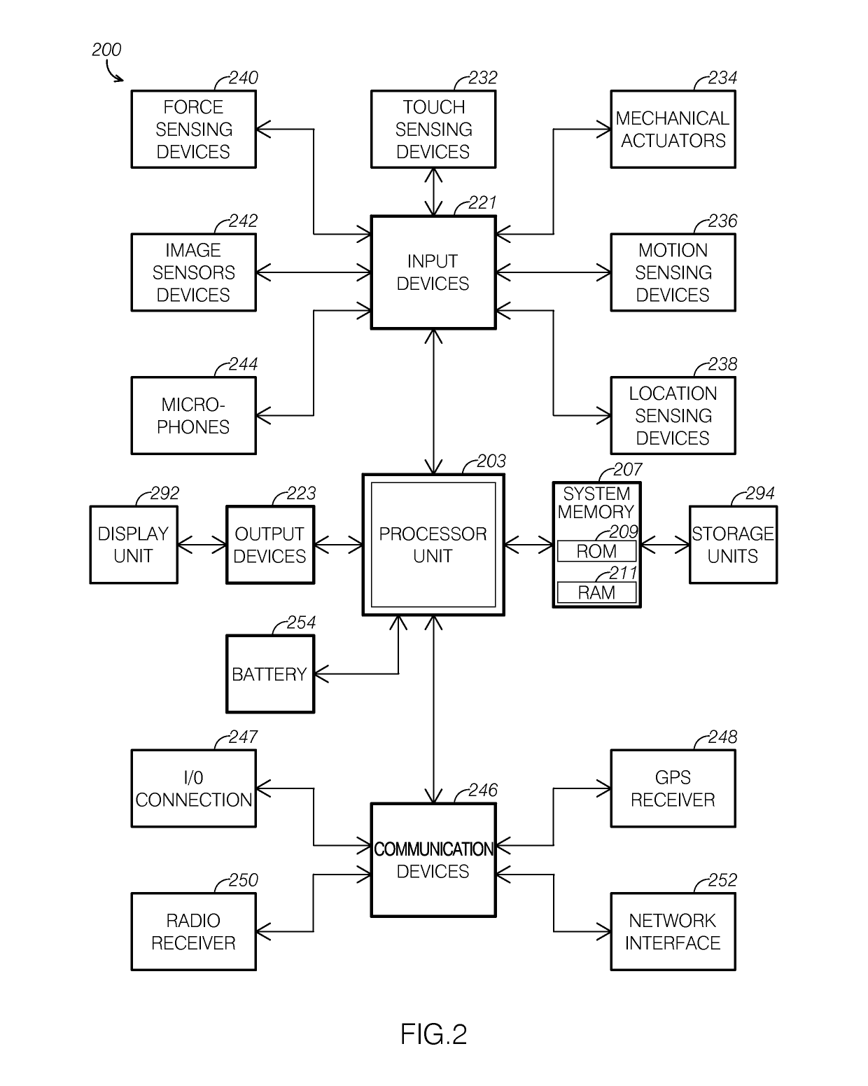

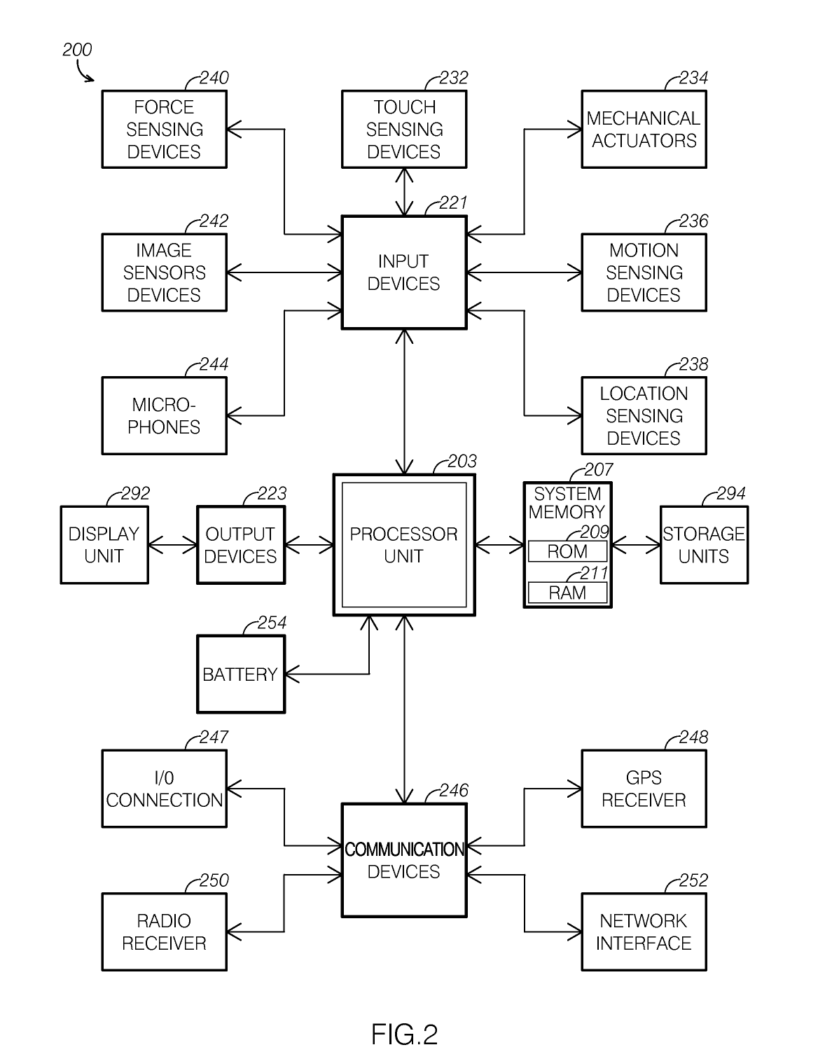

With reference to FIG. 2, an exemplary mobile device, mobile device 200, may include a processor unit 203 (e.g., CPU) configured to execute instructions and to carry out operations associated with the mobile device. For example, using instructions retrieved for example from memory, the controller may control the reception and manipulation of input and output data between components of the mobile device. The controller can be implemented on a single chip, multiple chips or multiple electrical components. For example, various architectures can be used for the controller, including dedicated or embedded processor, single purpose processor, controller, ASIC, etc. By way of example, the controller may include microprocessors, DSP, A/D converters, D/A converters, compression, decompression, etc.

In most cases, the controller together with an operating system operates to execute computer code and produce and use data. The operating system may correspond to well-known operating systems such iOS, Symbian, Windows-based (including Windows Mobile and Windows 8), or Android operating systems, or alternatively to special purpose operating system, such as those used for limited purpose appliance-type devices. The operating system, other computer code and data may reside within a system memory 207 that is operatively coupled to the controller. System memory 207 generally provides a place to store computer code and data that are used by the mobile device. By way of example, system memory 207 may include read-only memory (ROM) 209, random-access memory (RAM) 211. Further, system memory 207 may retrieve data from storage units 294, which may include a hard disk drive, flash memory, etc. In conjunction with system memory 207, storage units 294 may include a removable storage device such as an optical disc player that receives and plays DVDs, or card slots for receiving mediums such as memory cards (or memory sticks).

Mobile device 200 also includes input devices 221 that are operatively coupled to processor unit 203. Input devices 221 are configured to transfer data from the outside world into mobile device 200. As shown, input devices 221 may correspond to both data entry mechanisms and data capture mechanisms. In particular, input devices 221 may include touch sensing devices 232 such as touch screens, touch pads and touch sensing surfaces, mechanical actuators 234 such as button or wheels or hold switches, motion sensing devices 236 such as accelerometers, location detecting devices 238 such as global positioning satellite receivers, WiFi based location detection functionality, or cellular radio based location detection functionality, force sensing devices such as force sensitive displays and housings, image sensors, and microphones. Input devices 221 may also include a clickable display actuator.

Mobile device 200 also includes various output devices 223 that are operatively coupled to processor unit 203. Output devices 233 are configured to transfer data from mobile device 200 to the outside world. Output devices 233 may include a display unit 292 such as an LCD, speakers or jacks, audio/tactile feedback devices, light indicators, and the like.

Mobile device 200 also includes various communication devices 246 that are operatively coupled to the controller. Communication devices 246 may, for example, include both an I/O connection 247 that may be wired or wirelessly connected to selected devices such as through IR, USB, Bluetooth, NFC, or Firewire protocols, a global positioning satellite receiver 248, and a radio receiver 250 which may be configured to communicate over wireless phone and data connections. Communication devices 246 may also include a network interface 252 configured to communicate with a computer network through various means which may include wireless connectivity to a local wireless network, a wireless data connection to a cellular data network, a wired connection to a local or wide area computer network, or other suitable means for transmitting data over a computer network.

Mobile device 200 also includes a battery 254 and possibly a charging system. Battery 254 may be charged through a transformer and power cord or through a host device or through a docking station. In the cases of the docking station, the charging may be transmitted through electrical ports or possibly through an inductance charging means that does not require a physical electrical connection to be made.

The various aspects, features, embodiments or implementations of the invention described above can be used alone or in various combinations. The methods of this invention can be implemented by software, hardware or a combination of hardware and software. The invention can also be embodied as computer-readable code on a computer-readable medium. The computer-readable medium is any data storage device that can store data which can thereafter be read by a computer system, including both transfer and non-transfer devices as defined above. Examples of the computer-readable medium include read-only memory, random access memory, CD-ROMs, flash memory cards, DVDs, magnetic tape, optical data storage devices, and carrier waves. The computer-readable medium can also be distributed over network-coupled computer systems so that the computer-readable code is stored and executed in a distributed fashion.

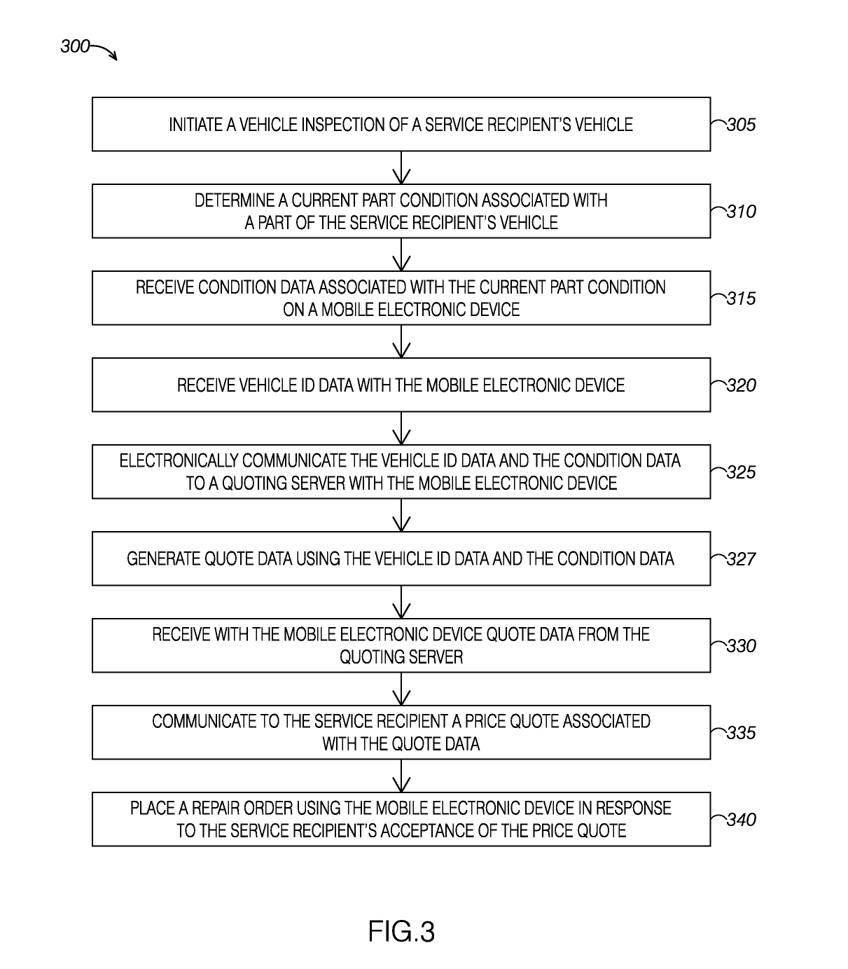

With reference to FIG. 3, an example of a method for quoting vehicle part repairs and tire replacement associated with vehicle inspections, method 300, will now be described. As FIG. 3 illustrates, method 300 includes initiating a vehicle inspection of a service recipient's vehicle at step 305, determining a current part condition associated with a part of the service recipient's vehicle at step 310, receiving condition data associated with the current part condition on a mobile electronic device at step 315, receiving vehicle identification data with a mobile electronic device at step 320, electronically communicating using the mobile electronic device the vehicle identification data and the condition data to a quoting server at step 325, generating quote data using the vehicle identification data and the condition data at step 327, receiving with the mobile electronic device quote data from the quoting server at step 330, communicating to the service recipient a price quote associated with the quote data at step 335, and placing a repair order using the mobile electronic device in response to the service recipient's acceptance of the price quote at step 340.

The disclosed methods may be particularly suited to parts that are easy to inspect upon an initial, superficial inspection, such as a “walk around” inspection. In particular, the disclosed systems and methods may be particularly suited for quoting tire services and other services on vehicles' exterior features. The disclosed systems and methods allow service consultants to enter condition data detected during an inspection and receive service quotes based on that condition data while remaining near the service recipient and/or the service recipient's vehicle, or at another desired location, such as a waiting room or in a service recipient's residence.

Further, generated quotes may automatically incorporate up-to-date pricing and part and employee availability information acquired from suppliers. After receiving a generated quote, service consultants can relay quote information to the service recipient and place repair orders based on their inspection without leaving the vicinity of the service recipient and/or the service recipient's vehicle. Alternatively or additionally, the service consultant can relay quote information to the service recipient and place repair orders at any desired location, such as in a waiting room at a service repair center or at a service recipient's residence. Thus, the disclosed methods may, as a result, lead to increased sales, because they reduce the likelihood that service consultants fail to accurately complete the quoting process in a timely manner. Moreover, service consultants are better able to provide high quality customer service to the service recipient and the system is adaptable to a variety of service environments (e.g., a service recipient's residence, a service center, a location where a vehicle is parked and inoperable, etc.).

As FIG. 3 illustrates, a vehicle inspection is initiated for a service recipient's vehicle at step 305. In some examples, the service consultant inspects service recipients' vehicles at a tire replacement facility or other automobile service center. In other examples, however, the service consultant inspects a service recipient's vehicle at a remote location away from a service center or tire replacement facility, such as at the service recipient's residence or at a location where a vehicle is parked and inoperable.

When service consultants inspect service recipients' vehicles at remote locations, service consultants may be equipped with mobile electronic devices configured to wirelessly communicate with a quoting server over a network connection, such as a cellular data network. When so equipped, service consultants may seamlessly provide quotes to service recipients while away from service centers with a minimal reduction in functionality or quality of service.

This disclosure focuses on examples including quick, visual inspections of the conditions of service recipients' vehicles or parts thereof, or “walk around” inspections, performed while the service recipient remains in his vehicle. In such a “walk around” inspection, service consultants often visually inspect the exterior features service recipient's vehicle and note their observations. In some examples, however, more detailed inspections may be performed using the systems and methods described herein.

In some examples, service consultants often use a mobile electronic device, which may have substantially similar features to mobile electronic device 200, to assist the vehicle inspection. In some specific example, initiating a vehicle inspection can include turning on and opening a vehicle inspection program on the mobile electronic device. The vehicle inspection program can be instructions for a computer of the mobile electronic device stored on a non-transitory computer-readable medium.

As FIG. 3 shows, a current part condition associated with a part of the service recipient's vehicle (e.g., at least one part of the service recipient's vehicle) is determined at step 310. In some examples, service consultants simply visually and/or manually determine the condition of the parts of service recipients' vehicles as they perform their inspection. In some examples, service consultants may use tools during their inspection. In one specific example, a service consultant can use a ruler to measure tires' tread depth during their inspection.

In some examples, however, service consultants may employ interpretive software on the mobile electronic device that is able to automatically detect the condition of parts during the inspection. For example, some service consultants may photograph parts with the mobile electronic device's camera. In this example, the mobile electronic device is configured to automatically determine the conditions of photographed parts. Such interpretive software may, for example, implement neural network programming or other image recognition techniques to analyze the photographs.

In other examples, the interpretive software may provide additional or alternative ways of determining part conditions without any human interaction. For example, the mobile electronic device may be connected to cameras, or other visual input means, which are positioned to automatically capture images of parts when vehicles are parked in a particular position. The interpretive software may be able to process the resulting images to determine part conditions. Additionally or alternatively, the mobile electronic device may be configured to communicate with a computing device within a vehicle to automatically determine part conditions detected by the vehicle's computing device.

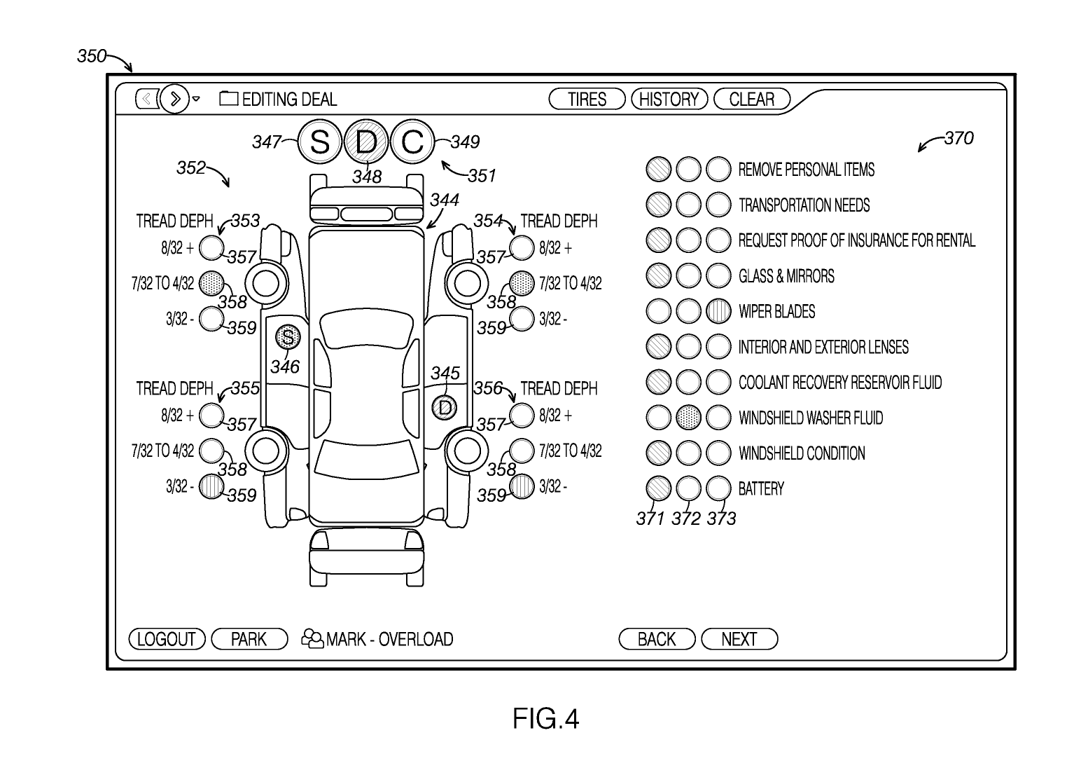

As FIG. 3 illustrates, condition data associated with the current part condition is received on a mobile electronic device at step 315. The condition data can be manually entered by the surface consultant and/or the condition data can be automatically received from the interpretive software for determining condition data. FIG. 4 illustrates an example of a graphical user interface (GUI), GUI 350 displayed on an Apple® iPad mobile electronic device, through which a service consultant may enter condition data.

As FIG. 4 illustrates, GUI 350 includes a tire condition field 352, a surface damage condition field 351, and an auxiliary condition field 370. As FIG. 3 shows, the user interface provides selectable entries that reflect current part conditions associated with a service recipient's vehicle as the service consultant performs an inspection. As FIG. 4 shows, GUI 350 is displayed on the touch-sensitive screen of an iPad mobile electronic device, allowing the service consultant to touch the screen to enter condition data associated with various parts' conditions as the service consultant inspects the vehicle.

Most of GUI 350's entries are selectable with a single tap, making it easy for service consultants to quickly enter data during an inspection. The condition data entered in GUI 350 may be stored on a storage unit of the mobile electronic device in a computer-readable format.

As FIG. 4 shows, the condition data may include tire condition data entered in tire condition field 352, which is associated with the condition of service recipient's tires at an inspection. Tire condition field 352 includes four tire sub-fields: a front left tire sub-field 353, a front right tire sub-field 354, a rear left tire sub-field 355, and a rear right tire sub-field 356. In the example show in FIG. 4, each tire sub-field allows the service consultant to enter the condition of each tire independently, allowing quotes and associated service orders to be tailored to the service recipient's particular circumstances and/or conditions of each of the vehicle's parts.

Also depicted in FIG. 4, each tire sub-field includes three tire condition entries: a good tire condition entry 357, a medium tire condition entry 358, and a poor tire condition entry 359. A service consultant performing an inspection may select the appropriate entries per his inspection. For example, in the screenshot displayed in FIG. 4, the service consultant's inspection determined that both front tires had a medium tire condition, and he/she accordingly selected medium tire condition entry 358 in front left tire sub-field 353 and front right tire sub-field 354. The service consultant further determined that both rear tires had a poor tire condition, and selected poor tire condition entry 359 in rear left tire sub-field 355 and rear right tire sub-field 356. In the present example, each tire sub-field allows only one of the three associated tire condition entries to be selected at a single time.

As FIG. 4 shows, each tire sub-field includes a touchscreen-selectable good tire condition entry 357, which service consultants may select to enter a good tire condition with respect to the associated tire. The displayed criteria are predetermined by the service consultant (or his/her employer). The good tire condition criteria is defined, in this example, as having tread depth of approximately 8/32 of an inch or greater. In some examples, a good tire condition indicates that the associated tire does not need any immediate repair or replacement.

Each selected good tire condition entry 357 can be filled with solid green coloration. The green coloration visually confirms to the service consultant that the appropriate entry was selected. Further, service recipients will instinctively recognize that green is associated with a good condition. Because the green coloration conveys this message, the service consultant can easily communicate the current tire condition to the service recipient by simply showing the display screen to the service recipient.

As FIG. 4 shows, each tire sub-form includes a touchscreen-selectable medium tire condition entry 358, which the service consultant may select to enter a medium tire condition. The displayed medium condition criteria are predetermined by the service consultant (or his employer). In this example, the medium tire condition criteria is defined as having tread depth between approximately 4/32 of an inch to approximately 7/32 of an inch. In some examples, a medium tire condition indicates that the associated tire may not need any immediate repair or replacement, but immediate attention may be helpful to prevent more severe tire damage in the near future.

Each selected medium tire condition entry 358 can be filled with solid yellow coloration. The yellow coloration visually confirms to the service consultant that the appropriate entry was selected. Further, service recipients will instinctively recognize that yellow is associated with a cautionary condition. Because the yellow coloration conveys this message, the service consultant can easily communicate the current tire condition to the service recipient by simply showing the display screen to the service recipient.

As FIG. 4 illustrates, each tire sub-field includes a touchscreen-selectable poor tire condition entry 359, which the service consultant may select to enter a poor tire condition with respect to the associated tire. The displayed poor condition criteria are predetermined by the service consultant (or his employer). As FIG. 4 illustrates, the poor tire condition criteria is defined, in this example, as having tread depth of approximately 3/32 of an inch or less. In some examples, a poor tire condition indicates that the associated tire needs immediate repair or replacement.

Each selected poor tire condition entry 359 can be filled with solid red coloration. The red coloration visually confirms to the service consultant that the appropriate entry was selected. Further, service recipients will instinctively recognize that red is associated with a dangerous condition. Furthermore, service recipients will instinctively recognize that their tires are dangerously worn and may need immediate replacement. Because the red coloration conveys this message, the service consultant can easily communicate the current tire condition to the service recipient by simply showing the display screen to the service recipient.

In some examples, the tread depths or ranges of tread depths associated with the good, medium, and poor tire conditions may be adjustable by service consultants, tire replacement facilities, or other automobile service centers. For example, service consultants (or their employers) may adjust these tread depths or ranges on a facility-wide basis. In some examples, the tread depths or ranges may be tailored to particular makes and models of vehicles and/or particular types of tires.

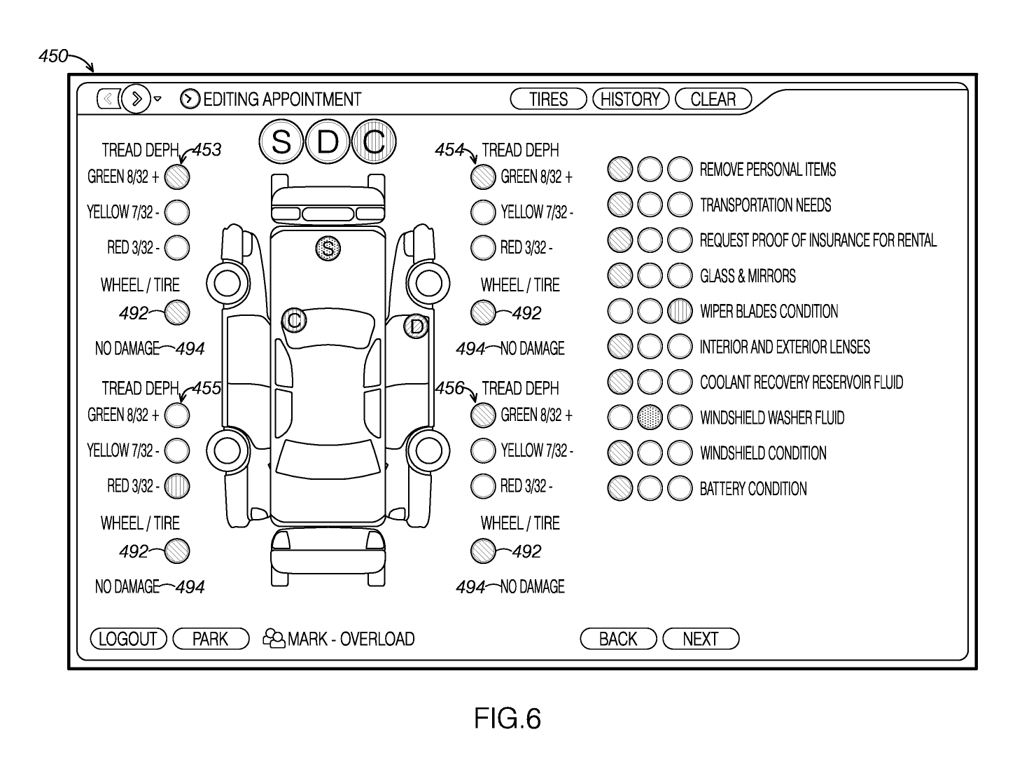

As FIG. 6 shows, some examples of tire condition fields, such as tire condition field 453, tire condition field 454, tire condition field 455, and tire condition field 456 included in user interface 450, include a wheel/tire damage indicator 492 and wheel/tire damage form 494. Wheel/tire damage form 494 allows service consultants to enter damage that the service consultant has determined exists with respect to each associated wheel and tire. Wheel/tire damage form 494 may allow users to enter damage not easily conveyed by the tread depth entries, such as punctures, nicks, or bubbles present on the tire or scratches, cracks, or breaks present on wheels.

In some example systems, the coloration of wheel/tire damage indicator 492 may be adjusted in response to the desired input. For example, some entries selectable in wheel/tire damage entry 494 may indicate no tire and/or wheel damage, and wheel/tire damage indicator 492 can be adjusted to a green coloration in response to selecting such an entry. In another example, some entries selectable in wheel/tire damage entry 494 may indicate some damage that does not require immediate replacement, and wheel/tire damage indicator 492 may be adjusted to a yellow coloration in response to selecting such an entry. Additionally or alternatively, some entries selectable in wheel/tire damage form 494 may indicate damage that requires immediate tire and/or wheel replacement, and wheel/tire damage indicator 492 may be adjusted to a red color in response to selecting such an entry.

It will be appreciated that the desired coloration for wheel/tire damage indicator 492 may be adjusted by multiple tap inputs on the touch screen. For example, a first tap may color wheel/tire damage indicator 492 a green coloration, a second additional tap may color wheel/tire damage indicator 492 a yellow coloration, and a third additional tap may color wheel/tire damage indicator 492 a red coloration. In other examples, the coloration may be selected by a different entry input method, such as a different number of tap inputs. In yet other example, the wheel/tire damage indicator may have three separate indicator sub-fields for entry of the wheel/time damage condition.

In other example systems and methods that include mechanism for automatically detecting part condition (i.e., employing interpretive software on the mobile electronic device that is able to automatically detect the condition of parts during the inspection), condition fields/sub-fields may be automatically populated by the interpretive software. In one example, condition data is received from the interpretive software rather than the service consultant. In another example, condition data can be received from both and/or either of the interpretive software and the service consultant.

In an the example where condition data is received from both and/or either of the interpretive software and the service consultant, condition data entries may be overridden by the service consultant if the interpretive software is believed to be in error. In another example where condition data is received from both and/or either of the interpretive software and the service consultant, some condition data may be entered by the interpretive software (e.g., tire condition sub-fields) and other condition data may be entered by the service consultant (e.g., wheel/tire damage entries).

Returning to FIG. 4, surface damage conditions 351 is shown, surface damage condition field 351 allows service consultants to enter condition data associated with damaged portions of the body of a service recipient's vehicle, such as scratched, dented, and chipped panels of a service recipient's vehicle. Accordingly, FIG. 4 illustrates, surface damage condition field 351 includes three entries: a scratch entry 347, a dent entry 348, and a chip entry 349.

To enter condition data using surface damage condition field 351, a service consultant may select one of scratch entry 347, dent entry 348, or chip entry 349. While the appropriate entry remains selected (e.g., scratch, dent, or chip), the service consultant may then select a portion of a vehicle diagram 344 displayed on GUI 350. When the user selects the damaged portion, an icon correlating to the type of damage is placed thereon. For example, FIG. 4 illustrates a dent icon 345 placed on the rear right door of vehicle diagram 344 in response to the service consultant touching the rear right door when dent entry 348 was selected. FIG. 4 additionally illustrates a scratch icon 346 placed on the front left door of vehicle diagram 344 by the service consultant touching the rear right door when dent entry 348 was selected.

As FIG. 4 shows, auxiliary condition field 370 includes entries associated with a plurality of auxiliary items for which the service consultant may enter condition data. Each element displayed in auxiliary condition field 370 includes three entries associated with each auxiliary item: a good auxiliary entry 371, a medium auxiliary entry 372, and a poor auxiliary entry 373. In some examples, the condition data may include auxiliary part condition data associated with one or more auxiliary parts that may be entered using one of the three entries associated with each auxiliary part.

In the illustrated example of FIG. 4, for instance, good auxiliary entry 371 indicates that no further action is necessary, medium auxiliary entry 372 indicates that service is advisable while repair isn't strictly required, while poor auxiliary entry 373 indicates that immediate repair is strongly advised. In some examples, good auxiliary entry 371 has a green coloration when selected, medium auxiliary entry 372 has a yellow coloration when selected, and poor auxiliary entry 373 has a red coloration when selected. Providing color indication to the auxiliary field entries has the advantages described above in reference color indication of tire sub-fields.

For example, FIG. 4 illustrates an example where a service recipient's wiper blades poor auxiliary entry 373 (e.g., having a red coloration) associated with “Wiper Blades Condition” has been selected because the service recipient's wiper blades are in very poor condition and require immediate replacement. Additionally, FIG. 4 illustrates an example where medium auxiliary entry 372 (e.g., having a yellow coloration) associated with “Windshield Washer Fluid” has been selected because a service recipient's windshield washer fluid is low while not necessarily requiring an immediate refill. In FIG. 4, good auxiliary entry 371 (e.g., having a green coloration) has been selected for all other parts, indicating that they do not need replacement or repair.

As FIG. 4 shows, auxiliary condition field 370 may additionally or alternatively be used for administrative tasks associated with a service order. For example, service consultants may need a reminder to check whether a service recipient has removed personal items from her vehicle, whether the service recipient has adequate transportation from the service location, and whether the service recipient has proof of insurance for a rental. In some examples, these administrative options may default to poor auxiliary entry 373 being selected until the service consultant actively selects good auxiliary entry 371 to indicate that the administrative task has been performed. The data may be used to properly record that these administrative steps were taken.

It will be appreciated that in some example systems and methods, service consultants, tire replacement facilities, or other automobile service centers are able to adjust the elements listed in auxiliary condition fields. For example, service consultants, tire replacement facilities, or other automobile service centers may add additional or alternative elements, each defaulting to the 3-option entry displayed in auxiliary condition field 370. In other examples, service consultants, tire replacement facilities, or other automobile service centers may remove elements from auxiliary condition fields; as a result, not every auxiliary condition field includes each and every element of auxiliary condition field 370.

It will be further appreciated that in alternate examples, the auxiliary field can include only a single entry sub-field that can receive multiple taps to change a coloration of the sub-field entry. In this example, similar to the example above, green coloration can indicate a good auxiliary condition, yellow coloration can indicate a medium auxiliary condition, and red can indicate a poor auxiliary condition. In yet other examples, the auxiliary field may alternatively or additionally include fillable forms where the condition data is described in words rather than selectable entry buttons. In this example, the service consultant can include more detailed descriptions of vehicle part conditions and/or administrative tasks.

As described above, in other example systems and methods that include mechanism for automatically detecting part condition (i.e., employing interpretive software on the mobile electronic device that is able to automatically detect the condition of parts during the inspection), condition fields, sub-fields, and entries may be automatically populated by the interpretive software. In one example, condition data is received from the interpretive software rather than the service consultant. In another example, condition data can be received from both and/or either of the interpretive software and the service consultant.

In an the example where condition data is received from both and/or either of the interpretive software and the service consultant, condition data entries may be overridden by the service consultant if the interpretive software is believed to be in error. In another example where condition data is received from both and/or either of the interpretive software and the service consultant, some condition data may be entered by the interpretive software (e.g., “Battery Condition”, “Coolant Recovery Reservoir Fluid”, etc.) and other condition data may be entered by the service consultant (e.g., “Wiper Blades Condition”, “Glass & Mirrors Condition”, etc.).

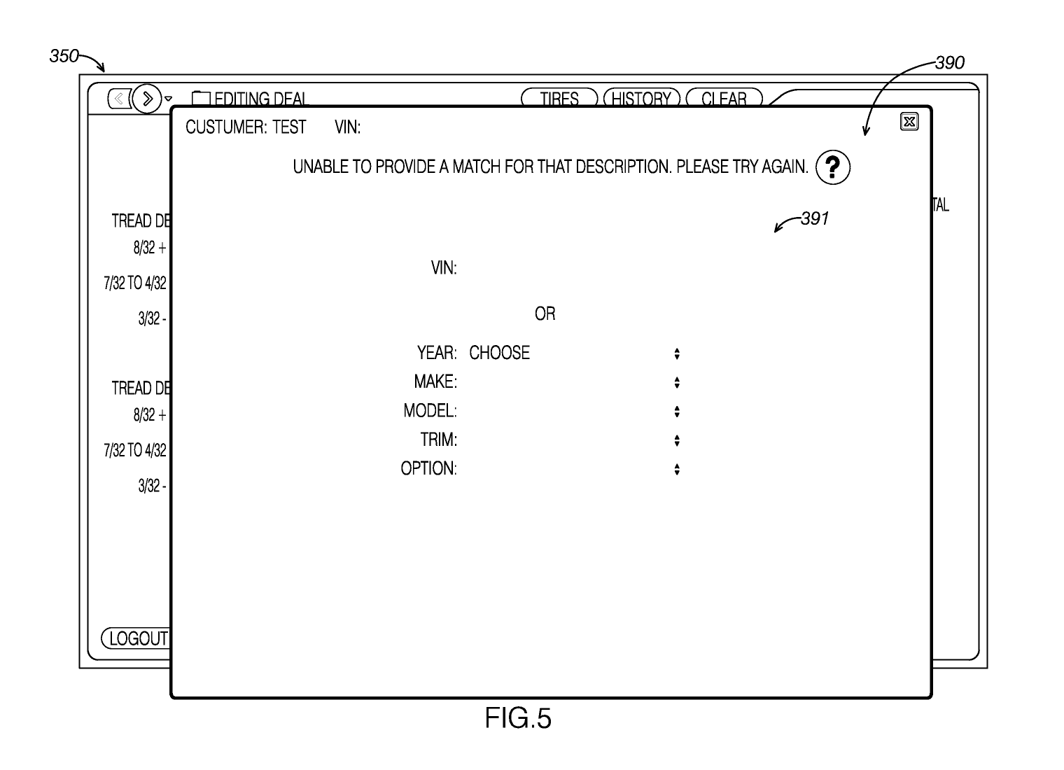

As FIG. 3 illustrates, vehicle identification data is received with the mobile electronic device at step 320. As FIG. 5 shows, GUI 350 includes a vehicle identification dialog 390 configured to manually receive vehicle identification data from a user, such as a service consultant or a service recipient. The vehicle identification dialog includes a vehicle identification form 391, which includes entries that allow a service consultant to identify the vehicle.

In the present example, the service consultant can have two optional fields for entering the vehicle identification data. In a first field, the service consultant can enter the vehicle identification number (VIN) associated with the vehicle. In a second field, the service consultant may enter in characteristics of the vehicle, such as the year, make, model, trim, and options of the vehicle. This vehicle identification data may be used to properly identify appropriate parts to use for repairs or replacements of damaged or worn features of the service recipient's vehicle. By properly identifying parts based on the vehicle identification data, the disclosed methods may produce more accurate quotes.

In some examples, the mobile electronic device is configured to automatically detect the vehicle identification data from a service recipient's vehicle, such as through a scanner configured to read a code displayed on the vehicle. In some examples, the mobile electronic device is connected an electronic communication device, such as an RFID tag or reader, paired with an electronic communication device positioned within the vehicle, such as a complimentary configured RFID tag or reader. In these examples, the vehicle identification data may be automatically populated in vehicle identification form 391.

In some examples, the mobile electronic device may generate the condition data and vehicle identification data and store the generated data on a storage unit in a computer-readable format in response to the service consultant entering data into GUI 350. The generated condition data and vehicle identification data can be used to generate a printable document summarizing condition data and/or vehicle identification data. In some examples, the GUI includes a “print” command button for a user (e.g., the service consultant or the service recipient) to order a printed version of the document summarizing condition data and/or vehicle identification data.

As FIG. 3 shows, the vehicle identification data and the condition data are communicated electronically to a quoting server using the mobile electronic device at step 325. The quoting server defines a network connected computing device that stores dealer management information. In some examples, the quoting server may additionally or alternatively acquire dealer management information from a network location (e.g., internet-connected hosts) to acquire, for example, current inventories, pricing for parts, pricing for services, time estimate for service tasks, employee availability for service tasks, and other information that may be useful in generating a quote for a service recipient.

In some examples, the quoting server operates software allowing the mobile electronic device to connect over a wireless network, such as through a client/server architecture. When connected, the service consultant may automatically or near-automatically transmit condition data entered in during his inspection rather than moving to a distant computer to manually enter the data. This allows the service consultant to remain near the service recipient and/or the service recipient's vehicle, or any desired location. This allows the service consultant to provide a higher degree and more time efficient customer service to the service recipient.

In some examples, only a portion of the condition data may be sent, resulting in a quote for servicing only a portion of the inspected wear and damage. This may be useful, for example, when service recipients want to only repair the most significant problems.

Because service consultants often forget to go through the tire quoting process in conventional inspection methods, the ability to instantly communicate inspection results may provide particular benefits with regard to the tire quoting process. By allowing service consultants to efficiently communicate tire inspection results to the quoting server, the likelihood of forgetting to take this step is reduced significantly.

In some examples, the mobile electronic device prompts the service consultant to quote a service recipient's tires whenever a poor tire condition is entered or detected. In one specific example, the mobile electronic device displays a dialog box and/or quoting interface immediately in response to a service consultant submitting a tire condition form with a selected poor tire condition entry. In another specific example, the mobile electronic device immediately displays a dialog box and/or quoting interface in response to a poor tire condition being entered by the service consultant or being automatically detected by the mobile device. In some examples, mobile electronic devices require a user to complete a tire quote prior to executing any other operations or features within the mobile electronic device's software.

In particular, mobile electronic devices may not verify that the service consultant completed service until completing the quoting process when a poor tire condition has been entered. In other examples, mobile electronic devices do not allow service consultants to receive payment, produce an invoice, or otherwise complete a transaction with the customer prior to completing the quoting process whenever a poor tire condition has been entered. In some other examples, the mobile electronic device automatically includes a quote for a service recipient's tires whenever a poor tire condition is entered or detected.

As described above, in some example systems and methods, the condition data may be automatically communicated to the mobile electronic device. For example, the software on the mobile electronic device, or other computing device operated by the service consultant, may automatically determine the current part condition associated with one or more parts of the service recipient's vehicle. The mobile electronic device may, in response, automatically send the automatically generated condition data to the mobile electronic device without further user interaction.

Returning to FIG. 3, in method 300, quote data is generated with the quoting server using the vehicle identification data and the condition data at step 327. In some examples, the quoting server may read and translate the condition data and vehicle identification data received from the mobile electronic device to generate quote data. The quote data may, for example, include prices for parts and services required for repairs responsive to the inspection. The quote data may additionally or alternatively include, for example, scheduling estimates accounting for the availability of parts and/or service technicians needed to service the matters detected in the inspection. The vehicle identification data may help ensure that the quote data accurately reflects the parts and services that are needed for the service recipient's specific vehicle.

In some examples, the quoting server may be configured to receive part pricing and availability information from external systems, such as internet hosts. This may allow the quoting server to incorporate accurate, up-to-date part availability and pricing information into the quote data.

Based on tire condition field 352, for example, the quoting server may be configured to automatically retrieve currently available supplies of tires compatible with the service recipient's vehicle to determine if the service recipient's tires can be repaired immediately. Further, the quoting server may retrieve suppliers' current prices and availability with regard to tires compatible with the service recipient's vehicle. Additionally or alternatively, the quoting server may be configured to automatically retrieve a schedule of available technicians in order to determine if the service recipient's tires can be repaired immediately.

In some examples, the quoting server may store, on a storage unit, quote data generated by cross-referencing the condition data with the vehicle identification data and the dealer management information. This may be stored in one of many computer-readable formats described above.

As FIG. 3 illustrates, quote data is received with the mobile electronic device from the quoting server at step 330. After generating the quote data, the quoting server may wirelessly communicate the quote data to the mobile electronic device. In some examples, the mobile electronic device may display the received quote data on a display unit. In other examples, the quote data may be stored by the mobile electronic device on a storage unit.

By communicating the price quote to the service consultant's mobile electronic device, the service consultant is provided with a price quote while remaining near the service recipient and/or the service recipient's vehicle, which reduces the need for service consultants to leave the service recipient to retrieve a printed quote. This further reduces the need for service recipients to wait as service consultants perform tasks away from the service recipient and/or the service recipient's vehicle.

In particular, this may be useful in the context of quoting tire repairs. By sending condition data and receiving quote data without leaving the vicinity of the service recipient and/or the service recipient's vehicle, the opportunity for service consultants to forget to go through the tire quoting process is significantly reduced. Indeed, the service consultant never necessarily needs to leave the vicinity of the service recipient and/or the service recipient's vehicle. Using the methods described above, the service consultant may be able to inspect the service recipient's tires and receive, after the inspection, a near-instant quote to display to the service recipient. Further, the service recipient may immediately respond to the quote (e.g., acceptance or decline of services).

FIG. 3 further illustrates that a price quote associated with the quote data is communicated to the service recipient at step 335. In some examples, the quote data may be communicated to the service recipient while the service consultant remains near the service recipient's vehicle. In some examples, this may consist of displaying to the service recipient a price quote displayed on a display unit of the mobile electronic device. Additionally or alternatively, however, the price quote may be communicated by e-mail, text message, phone, or other electronic means. Further, in other examples, the price quote may be printed by the service consultant selecting and “print” command, and the price quote may be given to the service recipient in a hardcopy form.

After communicating the price quote to the service recipient, the service recipient may accept or decline service (e.g., accept a total service, accept a partial service, decline service, etc.). As FIG. 3 shows, a service order is placed using the mobile electronic device in response to the service recipient's acceptance of the price quote at step 340.

In some examples, this may consist of receiving authorization from the service recipient to receive service according to the terms set forth in the price quote. In other examples, the service consultant may use the mobile electronic device to wirelessly submit a repair order based on the quote generated in response to the inspection. An associated dealer management server may then appropriately allocate parts and labor to service the service recipient's vehicle. In some examples, the dealer management server may further automatically place an order, immediately upon the repair order being submitted, for the parts required to complete service.

Additionally or alternatively, the service recipient may desire or be required to schedule an appointment for her service at a later date. In such examples, the service consultant may schedule the appointment for the service recipient on the mobile electronic device and communicate appointment data corresponding to the appointment to the dealer management server.

In some examples, the dealer management server may operate on the same device as the quoting server.

The illustrated examples shown in FIGS. 4-6 are executed on an iPad mobile electronic device, but this is not specifically required. For example, any other type of tablet computer may provide substantially similar functionality. Further, other network connected computing devices, such as notebook computers, may equally perform many features of the invention, such as the user input and network communication features of the invention. Notebook computers may, however, lack the portability of a mobile electronic device or other small form-factor computing device. Further, smartphones may provide substantially similar functionality as tablet computers, including, for example, touchscreen input and portability. Smartphones, however, often have considerably smaller screens than tablet computers. As a result, examples operating on smartphones may require redesigned, simple interfaces designed for their reduce screen size.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A vehicle inspection system for carrying out a vehicle inspection and providing a quote for repair of a service recipient's vehicle, the quote being provided to a service recipient at a desired location, the vehicle inspection system comprising:
a mobile device, the mobile device having a computer with a processor, a display screen, and a non-transitory computer-readable storage medium, the computer-readable storage medium having computer-readable instructions for:
displaying a graphical user interface,
receiving a command to initiate a vehicle inspection of the service recipient's vehicle,
determining at least one current part condition associated with at least one part of the vehicle,
receiving condition data associated with the at least one current part condition,
receiving vehicle identification data for the vehicle,
electronically communicating the condition data and the vehicle identification data to a quoting server,
receiving quote data from the quoting server, and
displaying a price quote associated with the quote data.

2. The vehicle inspection system of claim 1, wherein determining the at least one current part condition associated with the at least one part of the vehicle comprises one or more of automatically detecting a condition of the at least one part of the vehicle and manually detecting a condition of the at least one part of the vehicle.

3. The vehicle inspection system of claim 2, wherein the mobile device is configured to automatically detect the condition of the at least one part of the vehicle.

4. The vehicle inspection system of claim 3, wherein the mobile device has a camera for a service operator to position to capture image data of the at least one part of the vehicle, the camera configured to communicate the image data to the computer, the computer-readable instructions further comprising instructions for interpreting the image data to automatically determine the condition of the at least one part of the vehicle.

5. The vehicle inspection system of claim 2, wherein at least one peripheral device in communication with the mobile device is configured to automatically detect the condition of the at least one part of the vehicle.

6. The vehicle inspection system of claim 5, wherein the at least one peripheral device is at least one camera positioned to automatically capture image data of the at least one part of the vehicle when the vehicle is parked in a designated position, the at least one camera configured to communicate the image data to the mobile device, the computer-readable instructions further comprising instructions for interpreting the image data to automatically determine the condition of the at least one part of the vehicle.

7. The vehicle inspection system of claim 1, wherein the graphical user interface comprises a computer generated image of a vehicle representing the service recipient's vehicle.

8. The vehicle inspection system of claim 7, wherein receiving condition data associated with the at least one current part condition comprises one or more of automatically receiving condition data and manually receiving condition data, and
displaying the graphical user interface further comprises displaying the automatically received condition data related to the condition of the at least one part of the vehicle on a corresponding part of the computer generated image of a vehicle.

9. The vehicle inspection system of claim 7, wherein the display is a touch screen.

10. The vehicle inspection system of claim 9, wherein receiving condition data comprises one or more of automatically receiving condition data and manually receiving condition data, and
manually receiving condition data comprises receiving touch input from a service technician on the touch screen.

11. The vehicle inspection system of claim 7, wherein the computer generated image of a vehicle representing the service recipient's vehicle comprises a plurality of parts of the vehicle, the plurality of parts comprising at least a front of the vehicle, a right side of the vehicle, a rear of the vehicle, a left side of the vehicle, a top of the vehicle, a right front tire, a right rear tire, a left front tire, and a left front tire, and
the computer-readable instructions further comprise instructions for receiving and displaying condition data associated with the at least one current part condition independently for each of the plurality of parts.

12. The vehicle inspection system of claim 1, wherein receiving vehicle identification data for the vehicle comprises one or more of automatically detecting the vehicle identification data from the service recipient's vehicle and manually entering vehicle identification data.

13. The vehicle inspection system of claim 1, wherein the computer-readable instructions further comprise instructions for receiving one or more of an acceptance of service and a decline of service, and placing a repair order in response to receiving the acceptance of service.

14. The vehicle inspection system of claim 13, wherein the computer-readable instructions further comprise instructions for generating a contract in response to receiving the acceptance of service.

15. The vehicle inspection system of claim 1, wherein the quoting server acquires dealer management information from a network location to acquire one or more of current inventory data, price of parts data, price of service data, time estimate for service data, and employee availability data to generate quote data.

16. A vehicle inspection system for carrying out a vehicle inspection and providing a quote for repair of a service recipient's vehicle, the quote being provided to a service recipient at a desired location, the vehicle inspection system comprising:
a mobile device, the mobile device having a computer with a processor, a display screen, and a non-transitory computer-readable storage medium, the computer-readable storage medium having computer-readable instructions for:
displaying a graphical user interface having a computer generated image of a vehicle representing the service recipient's vehicle,
receiving a command to initiate a vehicle inspection of the service recipient's vehicle,
determining at least one current part condition associated with at least one part of the vehicle, instructions for determining the at least one current part condition being one or more of automatically determining the at least one current part condition and manually determining the at least one part condition,
receiving condition data associated with the at least one current part condition, instructions for receiving condition data associated with the at least one current part condition being one or more of automatically receiving condition data and manually receiving condition data,
receiving vehicle identification data for the vehicle, instructions for receiving vehicle identification data for the vehicle being one or more of automatically detecting the vehicle identification data from the service recipient's vehicle and manually entering vehicle identification data,
electronically communicating the condition data and the vehicle identification data to a quoting server,
receiving quote data from the quoting server,
displaying a price quote associated with the quote data,
receiving one or more of an acceptance of service and a decline of service, and
automatically placing a repair order in response to the acceptance of service.

17. The vehicle inspection system of claim 16, further comprising at least one camera, the at least one camera configured to capture image data of the at least one part of the vehicle and communicate the image data to the computer, the computer-readable instructions further comprising instructions for interpreting the image data to automatically determine the condition of the at least one part of the vehicle.

18. The vehicle inspection system of claim 16, wherein displaying the graphical user interface further comprises displaying the condition data related to the condition of the at least one part of the vehicle on a corresponding part of the computer generated image of a vehicle.

19. The vehicle inspection system of claim 18, wherein the computer generated image of a vehicle representing the service recipient's vehicle comprises a plurality of parts of the vehicle, the plurality of parts comprising at least a front of the vehicle, a right side of the vehicle, a rear of the vehicle, a left side of the vehicle, a top of the vehicle, a right front tire, a right rear tire, a left front tire, and a left front tire, and
the computer-readable instructions further comprise instructions for receiving and displaying condition data associated with the at least one current part condition independently for each of the plurality of parts.

20. A vehicle inspection system for carrying out a vehicle inspection and providing a quote for repair of a service recipient's vehicle, the quote being provided to a service recipient at a desired location, the vehicle inspection system comprising:
a mobile device, the mobile device having a computer with a processor, a display screen, and a non-transitory computer-readable storage medium, the computer-readable storage medium having computer-readable instructions for:
displaying a graphical user interface having a computer generated image of a vehicle representing the service recipient's vehicle, the computer generated image of a vehicle having a plurality of parts of the vehicle, the plurality of parts comprising at least a front of the vehicle, a right side of the vehicle, a rear of the vehicle, a left side of the vehicle, a top of the vehicle, a right front tire, a right rear tire, a left front tire, and a left front tire,
receiving a command to initiate a vehicle inspection of the service recipient's vehicle,
determining at least one current part condition associated with at least one part of the vehicle, instructions for determining the at least one current part condition being one or more of automatically determining the at least one current part condition and manually determining the at least one part condition,
receiving condition data associated with the at least one current part condition, instructions for receiving condition data associated with the at least one current part condition being one or more of automatically receiving condition data and manually receiving condition data,
receiving vehicle identification data for the vehicle, instructions for receiving vehicle identification data for the vehicle being one or more of automatically detecting the vehicle identification data from the service recipient's vehicle and manually entering vehicle identification data,
electronically communicating the condition data and the vehicle identification data to a quoting server,
receiving quote data from the quoting server,
displaying a price quote associated with the quote data,
receiving one or more of an acceptance of service and a decline of service, and
automatically placing a repair order in response to the acceptance of service; and
at least one camera, the at least one camera configured to capture image data of the at least one part of the vehicle and communicate the image data to the computer, the computer-readable instructions further comprising instructions for interpreting the image data to automatically determine the condition of the at least one part of the vehicle, wherein
displaying the graphical user interface further comprises displaying the condition data related to the condition of the at least one part of the vehicle on a corresponding part of the computer generated image of a vehicle independently for each of the plurality of parts.
